(19) United States
(12) Patent Application Publication
(10) Pub. No.: US 2006/0120718 A1
(43) Pub. Date: Jun. 8, 2006

(54) Optical transmission apparatus and optical transmission system

(75) Inventor: Hidezumi Natori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/174,494

(22) Filed: Jul. 6, 2005

(30) Foreign Application Priority Data
Dec. 8, 2004 (JP) 2004-354764

(51) Int. Cl. H04B 10/08

(52) U.S. Cl. 398/19

(57) ABSTRACT

In a transmission apparatus, a plurality of optical transceivers respectively generates optical signals. A plurality of transponders generates a plurality of optical signals to be multiplexed as a WDM signal from among a plurality of optical signals generated by the plurality of optical transceivers. An optical switch circuit is provided between the plurality of optical transceivers and the plurality of transponders and it switches the plurality of paths of the optical signals between them. The priorities of a plurality of optical signals to be multiplexed as a WDM signal are set in a management table. A detector detects communication conditions of the respective optical signals that are multiplexed as the received WDM signal. A control circuit switches the paths in the optical switch circuit on the basis of the priorities set by the management table when a fault is detected by the detector.

### BACKGROUND OF THE INVENTION

1. Field of the Invention

The present invention is related to an optical transmission apparatus and an optical transmission system for transmitting and receiving WDM signals.

2. Description of the Related Art

In order to realize an optical transmission technology enabling large-capacity and long-distance transmission for the rapid growth of the Internet in recent years, Wavelength Division Multiplexing (WDM) transmission technology has attracted attention. In WDM transmission, a plurality of optical signals is transmitted through an optical fiber utilizing a plurality of wavelengths that are different from each other.

Meanwhile, as a method of protecting transmission data from faults that occur in an optical transmission system, a redundant configuration of the system is implemented. For example, in the system described in patent literature 1, a transmission path is made redundant. During normal operation, signals with high priority are transmitted through the high priority line, while signals with low priority are transmitted through the low priority line. In the case where a line fault occurs in the high priority line, the transmission of low priority signals is stopped and high priority signals are transmitted via the low priority line. In this way, high priority signal service can be preserved. As an alternative method, a configuration where the transmission apparatus itself is redundant is conceivable.

[Patent literature 1] Japanese unexamined patent application publication No. 2003-504956 (abstract, FIG. 1, paragraph 0002)

In recent years, the transmission capacity of each wavelength that configures a WDM signal has increased in capacity dramatically. That is, even if a fault only occurs in one wavelength that configures a WDM signal, a large effect can be manifested. Therefore, it is desirable to provide a redundant configuration for each wavelength of a WDM transmission system.

If a redundant configuration is prepared for each wavelength, however, much investment in plant is required and there is a dramatic increase in the complexity of the configuration of the system and system cost. This is especially so, when redundancy is implemented through many stages to improve transmission quality, resulting in further component installation and higher cost.

### SUMMARY OF THE INVENTION

The present invention realizes a redundant configuration for each wavelength at low cost and with a simple configuration in an optical transmission system for transmitting and receiving WDM signals.

In order to attain the above-mentioned object, an optical transmission apparatus related to the present invention used in an optical transmission system for transmitting and receiving WDM signals that correspond to each other among nodes, comprises: a plurality of optical signal generators for respectively generating optical signals; a plurality of wavelength converters for generating a plurality of optical signals to be multiplexed as a WDM signal from among a plurality of optical signals generated by the plurality of optical signal generators; a optical switch circuit provided among the plurality of optical signal generators and the plurality of optical converters, for switching paths among these units; a priority setting unit for setting the priorities of the plurality of optical signals generated by the plurality of optical signal generators; a detection unit for detecting the condition of each optical signal that is multiplexed as the received WDM optical signal; and a control unit for changing paths in the optical switch circuit based on the set priority of the priority setting unit.

When a wavelength converter fault is detected by the detection unit in an optical transmission apparatus that is used in WDM transmission, the optical switch circuit switches the paths of the optical signals between the optical signal generator and the wavelength converter. The switching of the paths of optical signals is performed based on the priority that is set by the priority setting unit and thus the communications for an optical signal having a high priority are secured without requiring the redundant configuration of transmission apparatus or a transmission path.

In the optical transmission apparatus, it is appropriate that the control unit refers to the priority setting unit and switching the output destination of a first optical signal among the plurality of optical signals, corresponding to an optical signal in which a fault is detected by the detection unit, with the output destination of a second optical signal among a plurality of optical signals, which is being communicated and has a priority lower than that of the first optical signal in the optical switch circuit. In this case, the second optical signal is, for example, an optical signal having the lowest priority among the plurality of optical signals. In the optical switch circuit, a path of the first optical signal in which a fault is detected is switched with a path of the second switch signal in which a fault is not detected and which has a priority lower than that of the first signal. In this way, although the communications of the second optical signal having a low priority are stopped, the communications of the first signal having a high priority can be secured. Meanwhile, if this function is used, a redundant configuration of “N−M” stages is given to an optical signal having the M-th priority in the WDM transmission of N wavelengths (channels).

Further more, it is appropriate that a block unit provided between the optical switch circuit and the plurality of wavelength converters, for blocking the second optical signal in accordance with the control unit. In this way, the transmission apparatus on the reception side detects a fault in the transmission apparatus on the communicating side and it can perform processing to secure the communications of the optical signal having a high priority.

In the optical transmission apparatus, furthermore, it is appropriate that the control unit refers to the priority setting unit and switches the output destination of a third optical signal, among a plurality of optical signals, corresponding to an optical signal in which recovery of a fault is detected by the detection unit, with the output destination of a fourth optical signal, among the plurality of optical signals, which is not being communicated and has a priority higher than that of the third optical signal in the optical switch circuit. If the recovery of a fault is detected for one optical signal, communications are secured by switching the path of the optical signal having the highest priority among a plurality of optical signals in which faults have been detected with the path of the recovered optical signal.

The present invention is not limited to the above-mentioned optical transmission apparatus. Optical transmission systems, etc., that employ the optical transmission apparatus, are also included in the present invention.

According to the present invention, a redundant configuration for each wavelength is realized at low cost and with a simple configuration in an optical transmission system for transmitting and receiving WDM signals. Furthermore, two or more redundant configurations are provided to an optical signal having a high priority by halting the transmission of an optical signal having a low priority.

### BRIEF DESCRIPTION OF THE DRAWING

FIG. 1A is a schematic diagram showing the configuration of an optical transmission system;

FIG. 1B is a schematic diagram showing the general configuration of a transmission apparatus station (such as A or B) in the optical transmission system;

FIG. 2 is a block diagram of a transmission apparatus related to the present preferred embodiment;

FIG. 3 shows management tables that are referred to at the time of the control of a switch circuit;

FIG. 4 is a pattern diagram showing the transmission and receipt of data between two transmission apparatuses using WDM transmission (No. 1);

FIG. 5 is a pattern diagram showing the transmission and receipt of data between two transmission apparatuses using WDM transmission (No. 2);

FIG. 6 is a pattern diagram showing the transmission and receipt of data between two transmission apparatuses using WDM transmission (No. 3);

FIG. 7 explains the updating of data of the management table at each station when the A and B stations are under the conditions shown in FIG. 6;

FIG. 8 is a pattern diagram showing the transmission and receipt of data between two transmission apparatuses using WDM transmission (No. 4);

FIG. 9 is a pattern diagram showing the transmission and receipt of data between two transmission apparatuses using WDM transmission (No. 5);

FIG. 10 is a pattern diagram showing the transmission and receipt of data between two transmission apparatuses using WDM transmission (No. 6);

FIG. 11 explains the updating of a management table when a fault occurs in the second transponder at the station A;

FIG. 12 is a pattern diagram showing the transmission and receipt of data between two transmission apparatuses using WDM transmission (No. 7);

FIG. 13 is a pattern diagram showing the transmission and receipt of data between two transmission apparatuses using WDM transmission (No. 8);

FIG. 14 is a pattern diagram showing the transmission and receipt of data between two transmission apparatuses using WDM transmission (No. 9);

FIG. 15 explains the updating of data in management tables at the A and B stations when a transponder at the station A is recovered;

FIG. 16 is a pattern diagram showing the transmission and receipt of data between two transmission apparatuses using WDM transmission (No. 10);

FIG. 17 is a pattern diagram showing the transmission and receipt of data between two transmission apparatuses using WDM transmission (No. 11);

FIG. 18 explains the updating of data in management tables at the A and B stations when a transponder at the station A is recovered from a fault;

FIG. 19 is a pattern diagram showing the transmission and receipt of data between two transmission apparatuses using WDM transmission (No. 12);

FIG. 20 is a flowchart of basic operations at the station A and the station B, which communicates with the station A, when a fault occurs in a signal at the station A;

FIG. 21 is a flowchart of basic operations at the station A and the station B, which communicates with the station A, when a fault occurs in a signal at the station A;

FIG. 22 is a configuration example of another optical transmission apparatus (No. 1);

FIG. 23 is a configuration example of another optical transmission apparatus (No. 2);

FIG. 24 is a schematic diagram of a ring-shaped network configuration;

FIG. 25 is the management table of a transmission apparatus connected to a ring-shaped network;

FIG. 26 is a management table at each station before and after a fault occurs, in the ring-shaped network (No. 1); and

FIG. 27 is a management table at each station before and after a fault occurs, in the ring-shaped network (No. 2).

### DESCRIPTION OF THE PREFERRED EMBODIMENTS

The following is the detailed explanation of the preferred embodiment of the present invention in reference to the drawings.

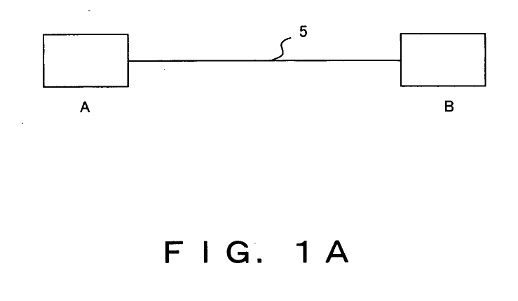

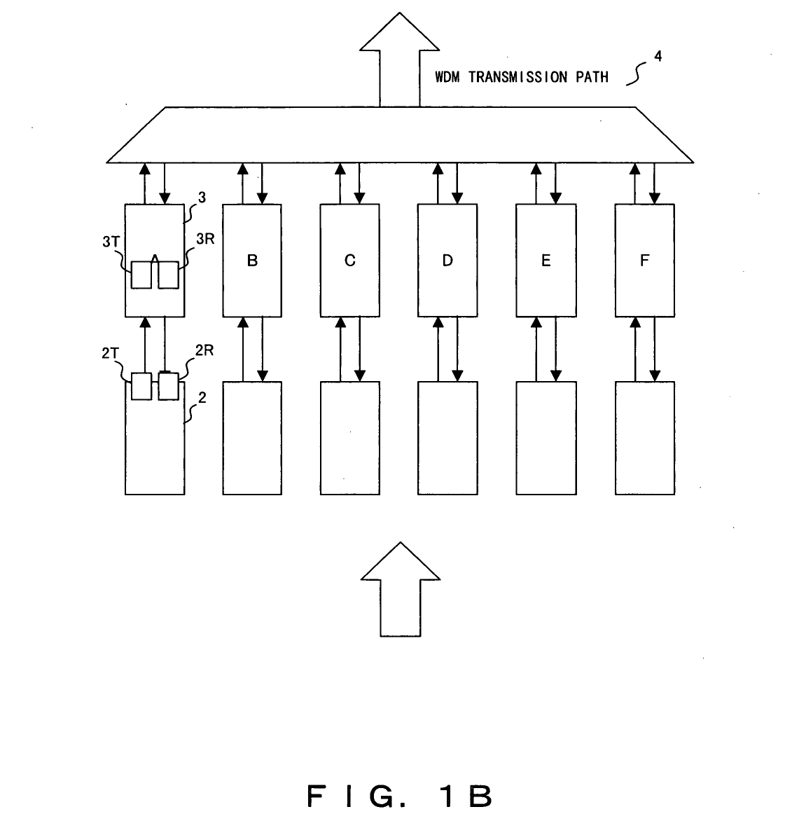

FIG. 1A is a schematic diagram of the configuration of an optical transmission system related to the present invention. The transmission apparatus station A and station B are connected by one pair of optical fibers that constitutes a WDM transmission path 5. Bi-directional communications of data are carried out by transmitting and receiving the optical signal that is multiplexed along the WDM transmission path 5. Here, a WDM (A-B) signal that is transmitted from the station A to the station B and a WDM (B-A) signal that is transmitted from the station B to the station A correspond to each other. In other words, if it is assumed that the WDM (A-B) signal and also the WDM (B-A) signal respectively include optical signals A to F, an optical signal A of the WDM (A-B) signal and an optical signal A of the WDM (B-A) signal are transmitted and received by the same user (or the same apparatus). Much the same is true of optical signals B to F. Therefore, the optical signal that is transmitted by a given station and the optical signal that is received from the communicating station are managed while in correspondence with each other, at the station A and station B. Then, when the optical signal that is transmitted using a port number n at the station A is received at the station B, an optical signal that is transmitted to the station A from the station B is also transmitted using the same port number n.

FIG. 1B is a block diagram briefly showing the general configuration of the transmission apparatus station A and station B in the optical transmission system. The transmission apparatus that is used in WDM transmission includes a plurality of optical transceiver apparatuses 2, a plurality of transponders (wavelength converter) 3 and a multiplex/demultiplex apparatus (MUX/DEMUX) 4. Each of the optical transceiver apparatuses 2 is provided with an optical transmission apparatus 2T and an optical reception apparatus 2R. The optical transmission apparatus 2T generates an optical signal that is transmitted to the transmission apparatus on the communicating side. The optical reception apparatus 2R receives the optical signal that is transmitted from the transmission apparatus on the communicating side. Each of the transponders 3 is provided with a wavelength converter for transmission 3T and a wavelength converter for reception 3R. The wavelength converter for transmission 3T converts the wavelength of the optical signal that is generated by the corresponding optical transmission apparatus 2T. At this time, conversion processing is performed in such a way that the wavelengths of the optical signals that are output from a plurality of the transponder 3 differ to each other. Furthermore, the wavelength converter for reception 3R converts the wavelength of an optical signal that is transmitted from the transmission apparatus on the communicating side. A multiplex/demultiplex apparatus (MUX/DEMUX) offers functions of multiplexing a plurality of optical signals to generate a WDM optical signal and demultiplexing the received WDM optical signal into its constituent signals (wavelengths).

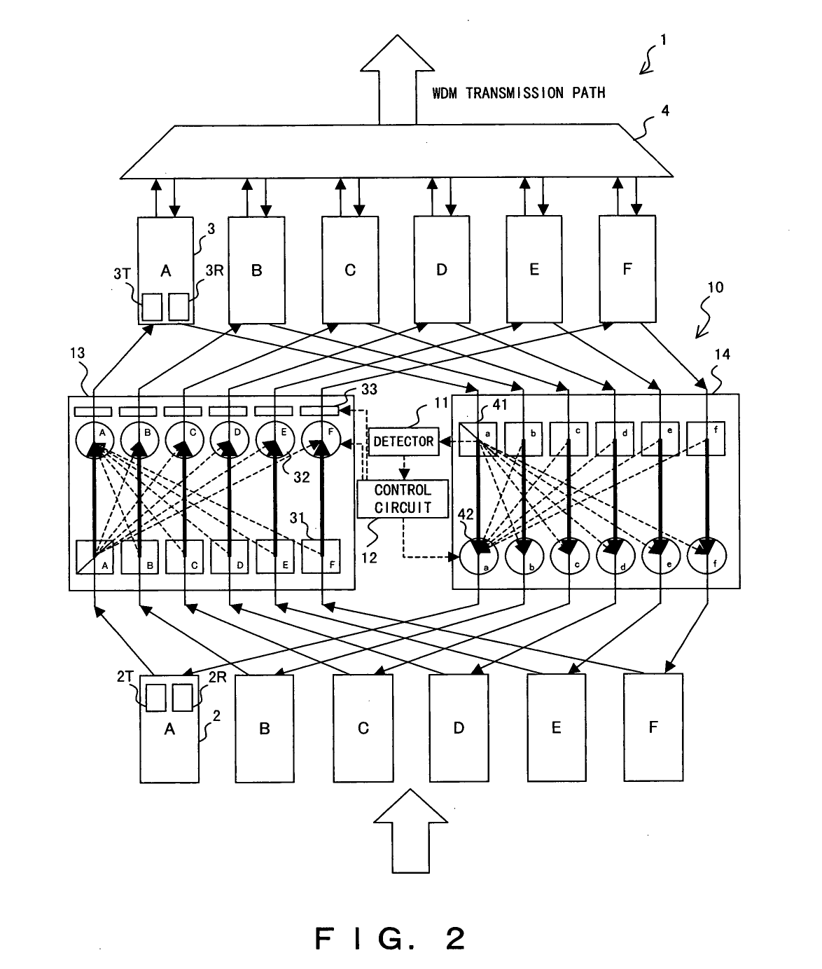

FIG. 2 is block diagram of a transmission apparatus related to the preferred embodiments of the present invention. In comparison with the general transmission apparatus shown in FIG. 1B, the transmission apparatus 1 related to the preferred embodiments of the present invention is further provided with a path switching apparatus 10 between the optical transceiver apparatus 2 and the transponder 3. The path switching apparatus 10 includes a detector 11 for detecting the condition of each optical signal that is included in the received WDM optical signal; a control circuit 12 for controlling each unit of the path switching apparatus 10 based on the detection results of the detector 11; a transmission signal switch circuit 13 for switching the paths of the optical signals transmitted to a plurality of transponders 3 from a plurality of optical transceiver apparatus 2 and a reception signal switch circuit 14 for switching the paths of the optical signals transmitted to a plurality of optical transceiver apparatus 2 from a plurality of transponders 3. The detector 11 detects the condition of each optical signal included in the received WDM optical signal to determine whether or not the optical power level reaches a predetermined threshold. Otherwise, it is appropriate that a packet is reassembled from the received optical signals and the detector detects the condition of the optical signal by checking the header of the packet.

The transmission signal switch circuit 13 is provided with six optical couplers 31, six optical switches 32 and six optical shutters 33. Each optical coupler 31 splits the optical signal that is generated by the corresponding optical transceiver apparatus 2 into six components. Each optical switch 32 selects and outputs the optical signal that is designated by the control circuit 12 from among the optical signals that are transmitted from six optical couplers 31. Each optical shutter 33 blocks the output of the corresponding optical switch 32 according to the instructions of the control circuit 12.

The reception signal switch circuit 14 comprises six optical couplers 41 and also six optical switches 42. Each optical coupler 41 splits the optical signal from the corresponding transponder 3 into seven components. Each optical switch 42 selects and outputs the optical signal that is designated by the control circuit 12 from among the optical signals that are transmitted from six optical couplers 41. Furthermore, one of the seven components split by the optical coupler 41 is guided to the detector 11 and the remaining six optical signals are respectively guided to six optical switches 42.

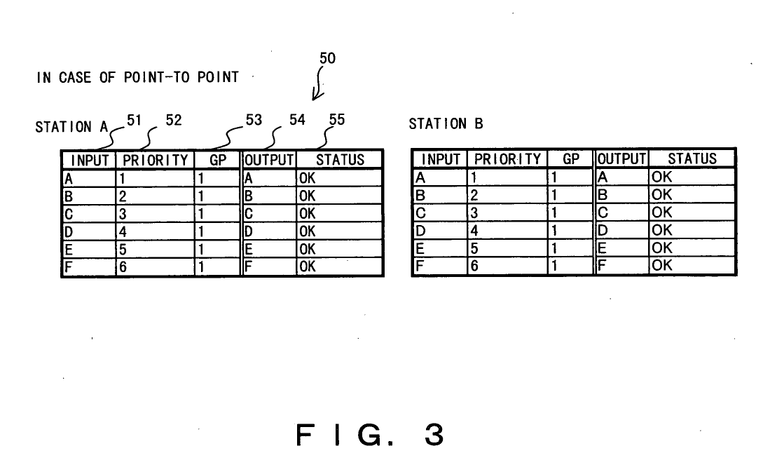

The control circuit 12 controls the transmission signal switch circuit 13 and the reception signal switch circuit 14 based on the condition of each reception optical signal that is detected by the detector 11. At this time, the control circuit 12 controls the respective paths inside the switch circuits 13 and 14 in reference to the table that is shown in FIG. 3.

FIG. 3 is a management table that is referred to at the time of controlling the switch circuits 13 and 14. The transmission apparatus 1 is provided with a management table 50 in memory, etc. inside the own apparatus. The management table 50 manages the information for designating the path of an optical signal and also the information about the priority of the optical signal that is transmitted or is received. The management table 50 includes an input source (port number on the optical transceiver side) 51, a priority 52, a group (GP) 53, an output destination (port number on the transmission path side) 54 and a status 55.

The information for identifying each optical transceiver apparatus 2 is stored at the input source 51. In the management table 50 of FIG. 3, the information about the six optical transceiver apparatuses that are shown in FIG. 2 is stored. The priority of the optical signal that is transmitted and received by each optical transceiver apparatus 2 (information about the relative importance of a relative communication) is stored as the priority 52. Where the smaller the numerical value of the priority 52 is, the higher the priority. The information for identifying each transponder 3 is stored as the output destination 54. The information about the six transponders 3 that are shown in FIG. 2 is stored in the management table 50 of FIG. 3. The information about the condition of each optical signal that is included in a WDM optical signal is stored in the status 55. Furthermore, the input source 51 and the priority 52 are set in advance, for example, by a manager, etc. The group 53 is explained later.

When the control circuit 12 detects a fault regarding a certain optical signal, it updates the status 55 in the management table 50 according to the detection results. At such a time, it refers to the priority 52 of each optical signal and changes the paths of the switch circuits 13 and 14, as occasion demands. Communications are performed by changing the paths of the switch circuits 13 and 14, changing the output destination 54 in the management table 50 and providing instructions to the optical switches 32 and 42 in accordance with the change results.

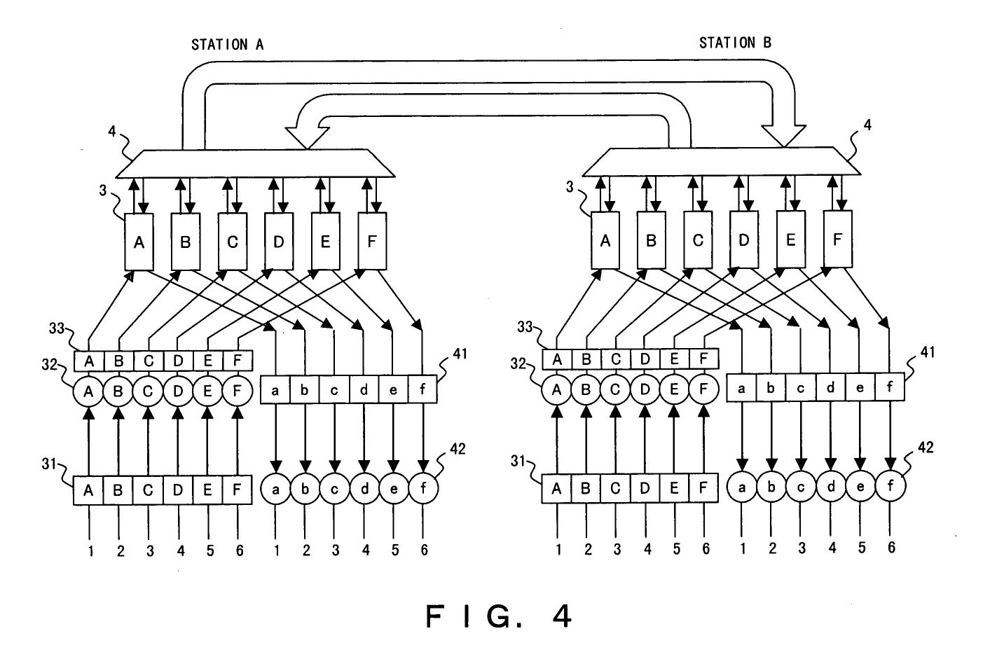

FIG. 4 is a schematic diagram showing the transmission and reception processing of a WDM signal between one set of transmission apparatuses. The management tables 50 of the station A and the station B under the conditions of FIG. 4 are shown in FIG. 3. When the operation of the transmission apparatus 1 is explained in FIG. 4 or the subsequent figures, the optical transceiver apparatus 2, the transponder 3 and the optical shutter 33 of which there are six pieces respectively, are expressed as optical transceiver apparatuses 2A, 2B, . . . , 2F, transponders 3A, 3B, . . . , 3F and optical shutters 33A, 33B, . . . , 33F, respectively.

In FIG. 4, the optical signals that are generated at present by the optical transceiver apparatuses 2A to 2F at the station A, are transmitted through the transponders 3A to 3F at the station A to be received by the optical transceiver apparatuses 2A to 2F at the station B through the transponders 2A to 2F at the station B. Similarly, the optical signals that are generated by the optical transceiver apparatuses 2A to 2F at the station B are transmitted through the transponders 3A to 3F at the station B to be received by the optical transceiver apparatuses 2A to 2F at the station A through the transponders 2A to 2F at the station A.

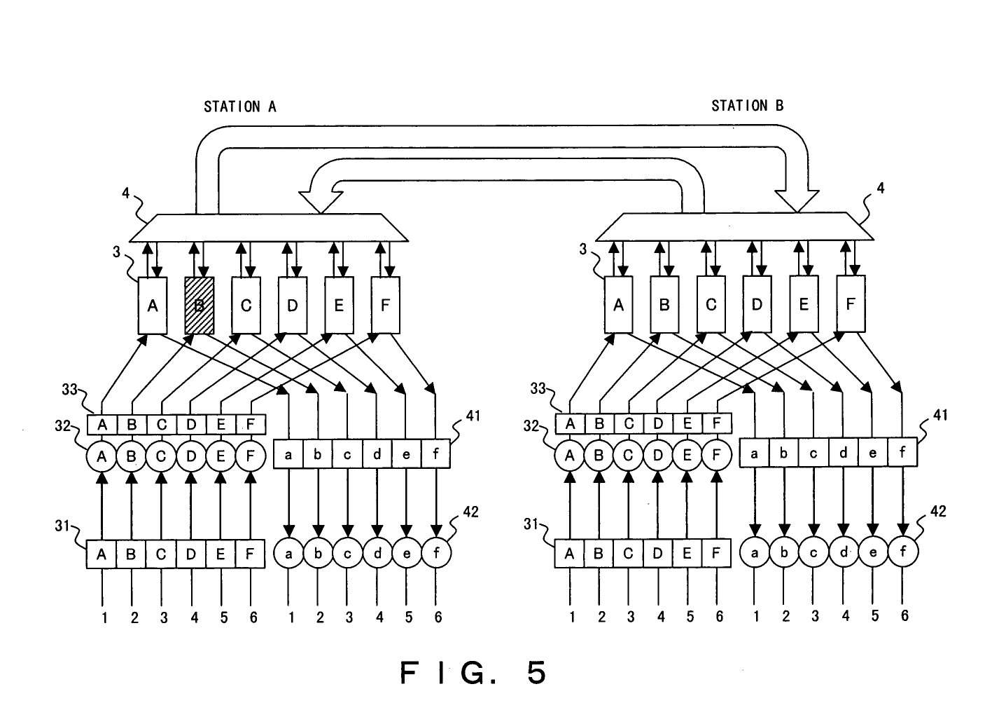

FIG. 5 is a pattern diagram showing the case where it is assumed that a fault has occurred in the transponder 3B at the station A. In FIG. 5, the transponder 3B in which a fault has occurred is indicated by shading. Due to the transponder 3B fault, the optical signal from among the optical signals that are transmitted to the station B from the station A, that is routed to transponder 3B is not received by the station B. When this condition is detected by the detector 11 at the station B, the control circuit 12 closes the optical shutter 33B of the transmission signal switch circuit 13 at the station B. By closing the optical shutter 33B at the station B, optical signals that are transmitted from the station B to the station A via the transponder 3B are not received at the station A. Meanwhile, any optical signal that is output from each of the optical transceiver apparatuses 2B at the station A and station B is designated as an optical signal B in the following explanation.

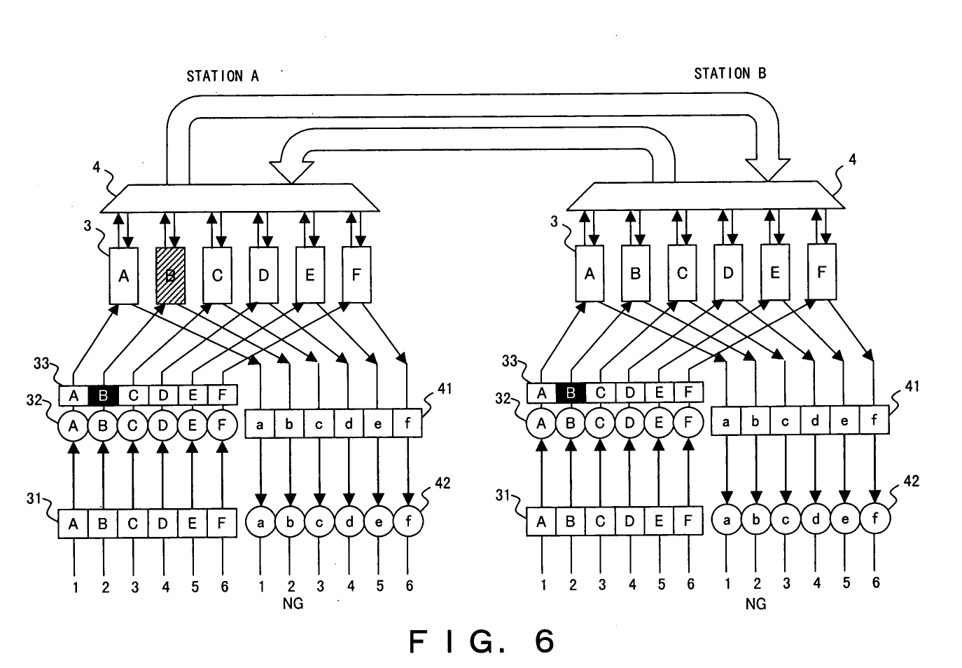

Similarly at the station A, a fault with regard to the optical signal B is detected by the detector 11 and then the control circuit 12 at the station A closes the optical shutter 33B. FIG. 6 shows the state in which the optical shutter 33B is closed at each of the stations A and B.

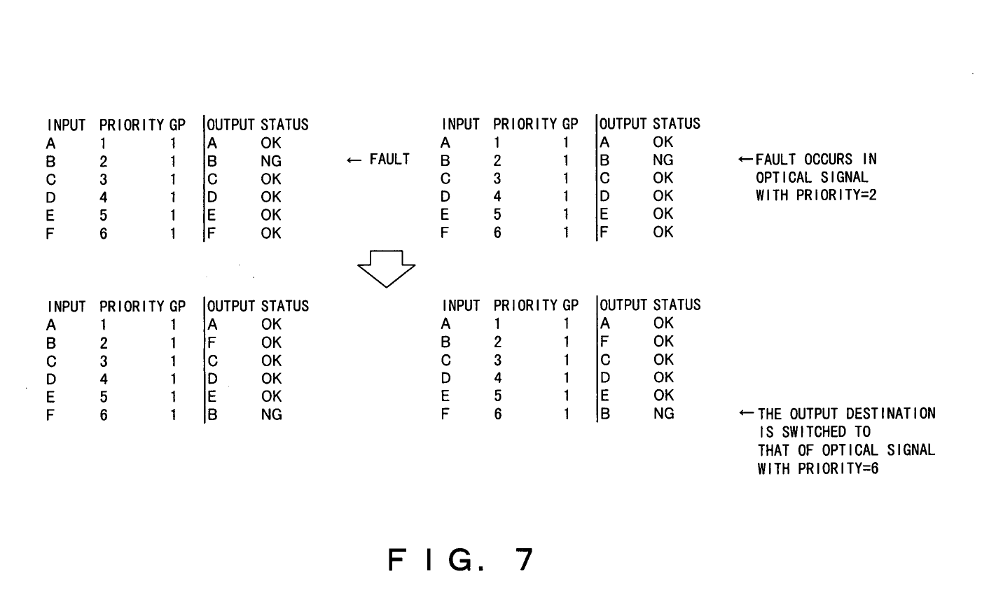

FIG. 7 explains the updating of the data of the management table 50 at each station when the stations A and B are under the conditions shown in FIG. 6. Among the four management tables 50 that are shown in FIG. 7, the two left tables are prepared for the station A while the two right tables are prepared for the station B. The upper two tables are those under the conditions in FIG. 6 while the lower two tables are obtained after data is updated by the control circuit 12 at each of the stations.

When the transponder 3B at the station A fails as shown in FIG. 5, the fault with regard to the optical signal B is detected at the station B and the status 55 is updated from “OK” to “NG”. Subsequently, when the fault is detected at the station A as shown in FIG. 6, the status 55 with respect to an optical signal B is updated to “NG” similarly in the management table 50 at the station A.

When the status 55 is updated to “NG”, the control circuit 12 switches “the output destination” of the optical signal in which a fault occurs with “the output destination” of an optical signal having a lower priority than that of the optical signal affected by the fault and with the status 55 of “OK”. At such a time, the optical signal having the lowest priority among the optical signals with a status 55 of “OK” is selected. In this example, the output destination of an optical signal B which experiences a fault is switched with the output destination of an optical signal F to which “priority=6” is set.

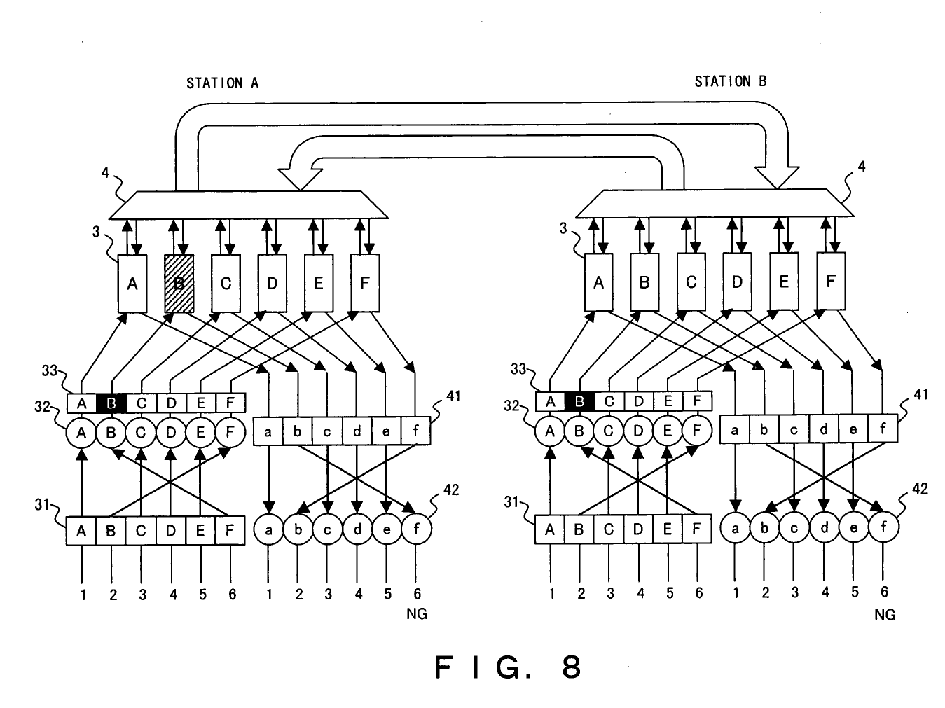

FIG. 8 shows the configuration after the output destination data are switched. As shown in FIG. 8, the path of the optical signal B having a high priority (priority=2) is switched with the path of an optical signal F having a low priority (priority=6) by the switch circuits 13 and 14 at the stations A and B. Consequently, the optical signal B having a high priority that is generated by the optical transceiver apparatus 2B is transmitted by utilizing the transponder 3F that has not failed. Therefore, communications using the optical signal B are secured between the station A and the station B. At such a time, however, the optical signal F having a low priority cannot be communicated.

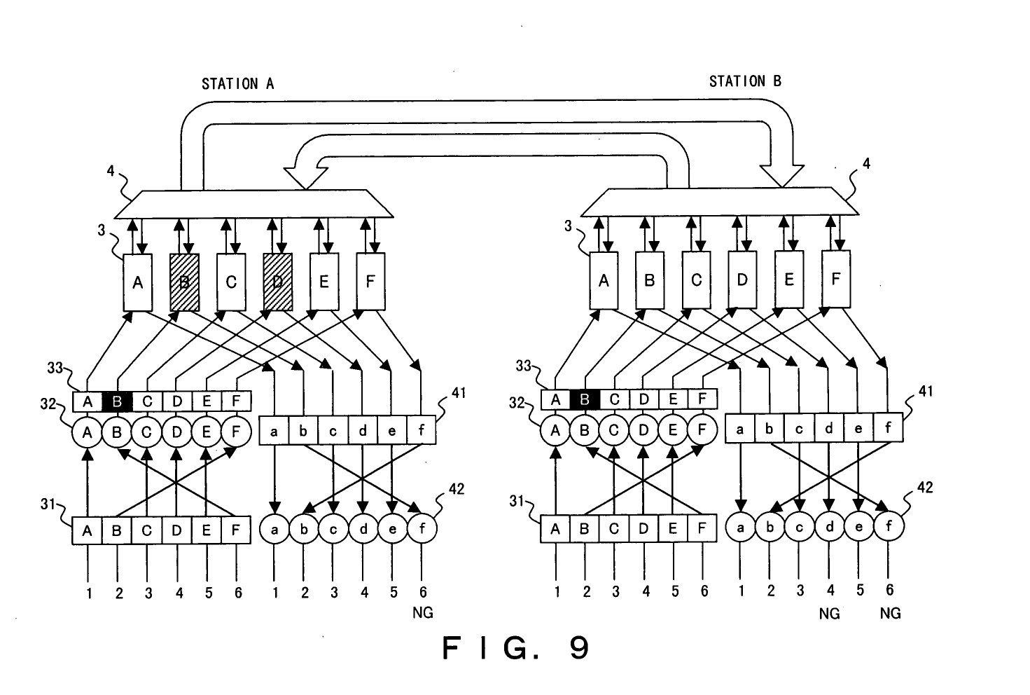

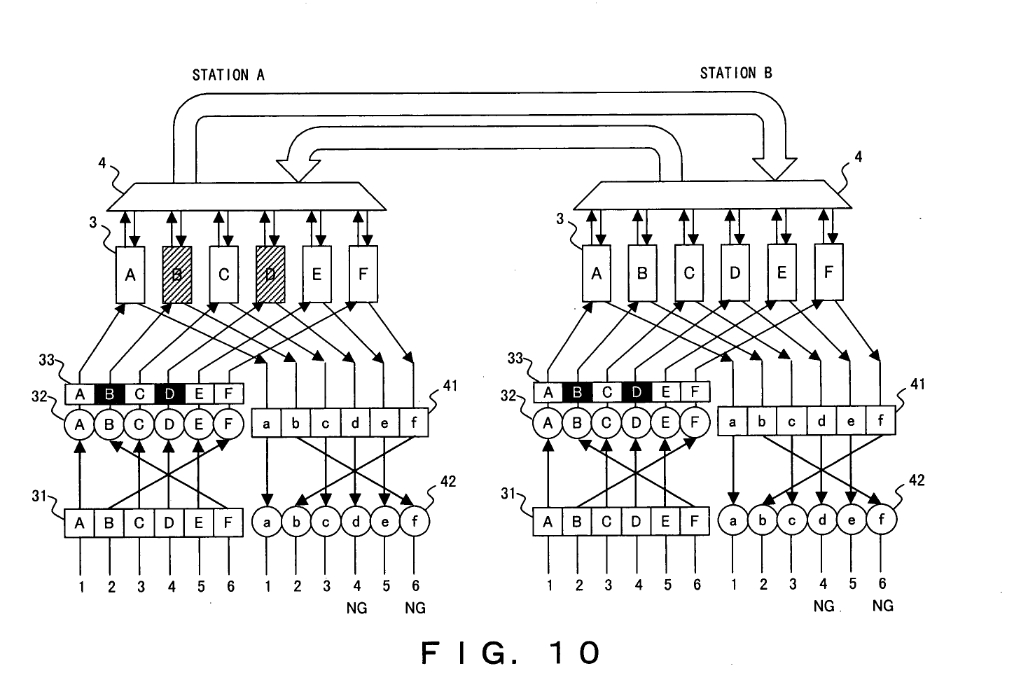

Following the fault of the transponder 3B at the station A, it is assumed that a further fault occurs in the transponder 3D at the station A. The condition of each station at this time is shown in FIG. 9. It is detected by the detector 11 at the station B that the optical signal D from the transponder 3D at the station A is not received at the station B. In the same way as was explained in reference to FIG. 6, the optical shutters 33D at the station B and the station A close to block the optical signal D. This condition is shown in FIG. 10.

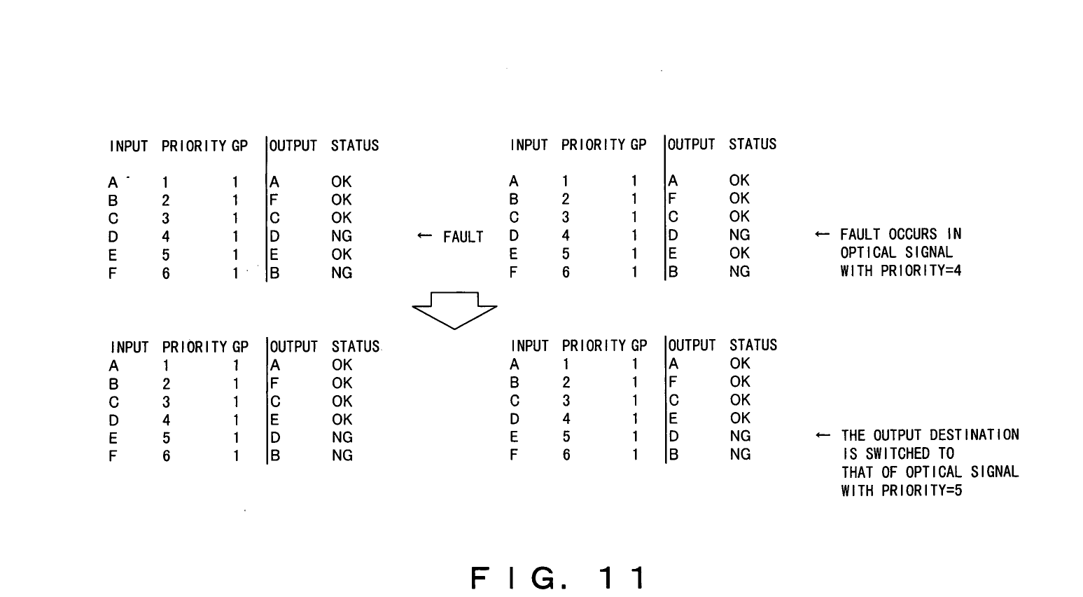

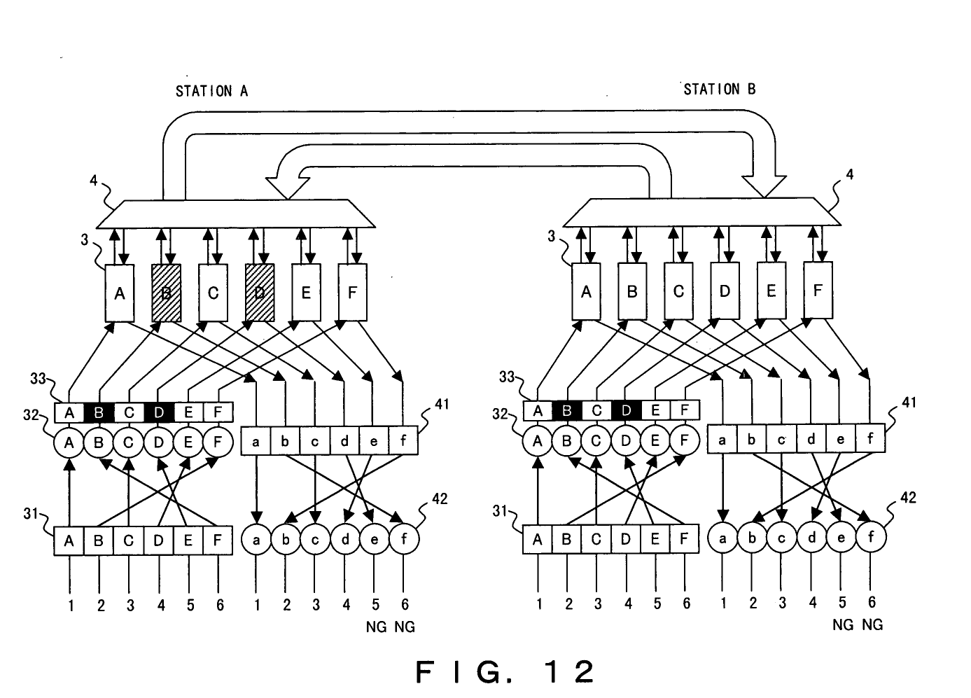

FIG. 11 explains the updating of a management table when a fault occurs in the transponder D at the station A. When the status 55 of the optical signal D in the management table 50 at the station A and B is updated to “NG”, the control circuit 12 retrieves from the management table 50, an optical signal having a priority lower than the optical signal D, in which a fault has not occurred during communications and switches the output destinations 54 in the case where a corresponding optical signal is present. Since a corresponding optical signal E is present in FIG. 11, the output destination of the optical signal D in which a fault occurs is switched with that of the optical signal E at both station A and station B. FIG. 12 shows the condition of communications after the output destinations 54 in the management table 50 are updated in respect to the optical signals D and E. At such a time, the optical signal D is transmitted using the transponder 3E in which a fault has not occurred so that communications between the station A and the station B are secured using the optical signal D.

In the case where a fault occurs in an optical signal, the path of this faulted optical signal is switched with that of an optical signal having a priority lower than that of the faulted optical signal and in which a fault has not occurred on the basis of the information that is managed by the management table 50. In this way, communications of an optical signal having a high priority can be secured.

Furthermore, in the above-mentioned preferred embodiment, it is assumed that the transponder 3B for transmitting the optical signal B having the second highest priority in a six channel WDM signal fails and the path of the optical signal B is switched with that of the optical signal F. In this case, the optical signal B is transmitted through the transponder 3F. Then, the optical signals A to E are transmitted and received between the station A and the station B. After this, if the transponder 3F fails, the path of the optical signal B is switched to, for example, that of the optical signal E. Then, the optical signal B is transmitted through the transponder 3E. After this, if a fault occurs in the same way, the optical signal B can use the transponders that are assigned to optical signals C and D each having a priority lower than that of optical signal B. That is, the optical signal B can use four transponders that are assigned to optical signals C to F each having a priority lower than its own. In other words, a redundant configuration of four stages is provided to the optical signal B.

When this is expressed as a general equation, it can be said that the redundant configuration of “N−M” stages is provided to each optical signal, where it should be noted that “N” is the number of channels of a WDM signal and “M” is the priority of each optical signal.

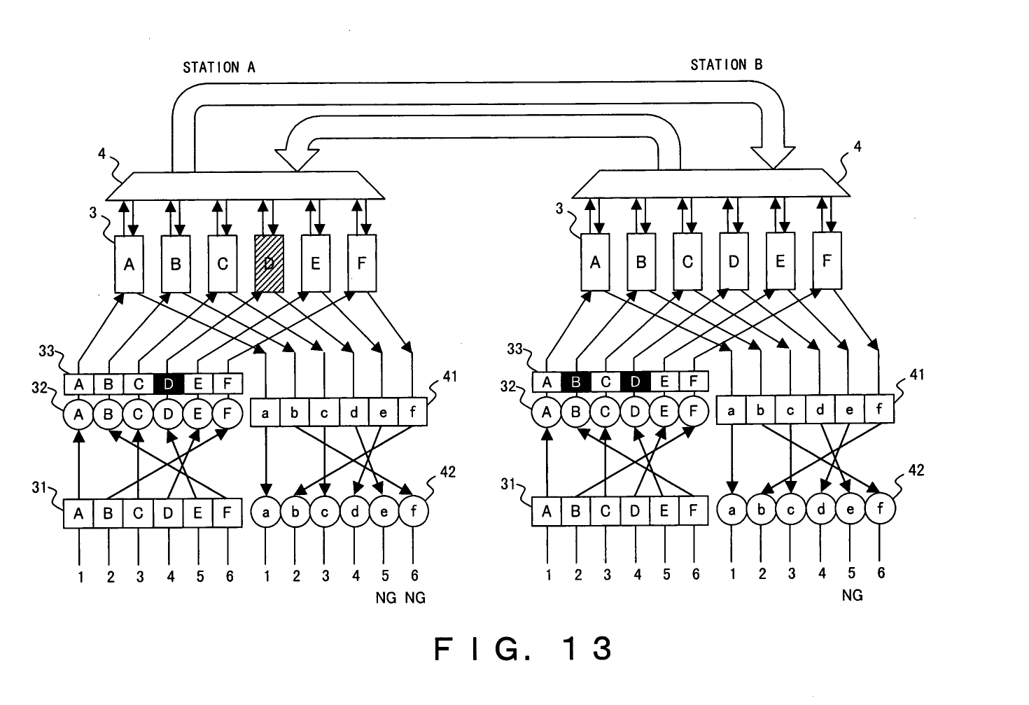

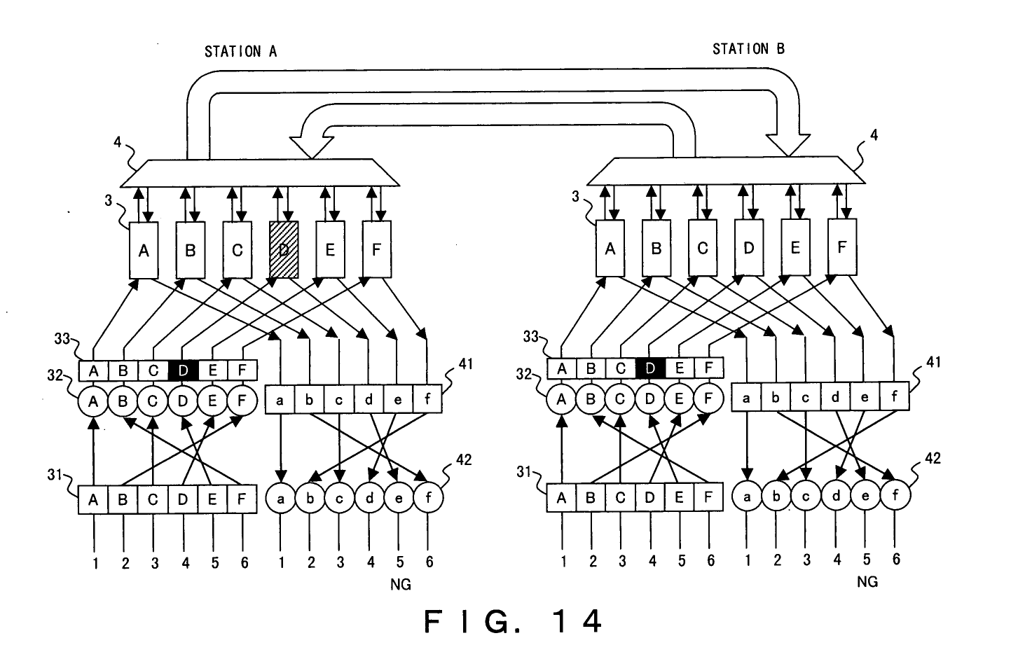

Subsequently, the operation of the transmission apparatus 1 related to the present preferred embodiment is explained in the case where the transponders 3B and 3D at the station A are sequentially recovered from faults. FIG. 13 is a pattern diagram showing the state of the system at the time when the transponder 3B at the station A is recovered from a fault. When the transponder 3B at the station A is recovered from a fault, the optical shutter 33B corresponding to the transponder 3B is opened, for example, manually, thereby passing the optical signal F. This optical signal F is detected at the station B and the status 55 corresponding to this optical signal F is updated from “NG” to “OK” in the management table 50. When it is detected that there is no fault in the status 55 at the station B, the optical shutter 33B is opened at the station B and the transmission of the optical signal F to the station A is started. When this optical signal F is detected at the station A, the status 55 corresponding to the optical signal F is updated to “OK” in the management table 50. When the status 55 in the management table 50 on the station A side reverts to OK, in other words, the optical signal F transmitted from the station B is detected, manual control of the optical shutter 33B at the station A is switched to automatic control. FIG. 14 is a pattern diagram showing the state of the system at the stage where the control of the optical shutter 33B at the station A is switched to automatic control.

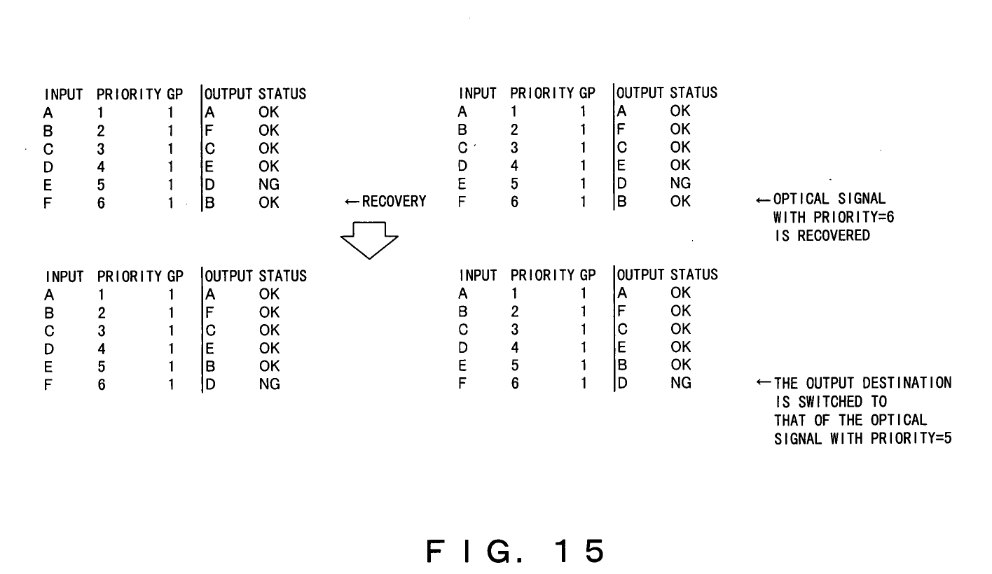

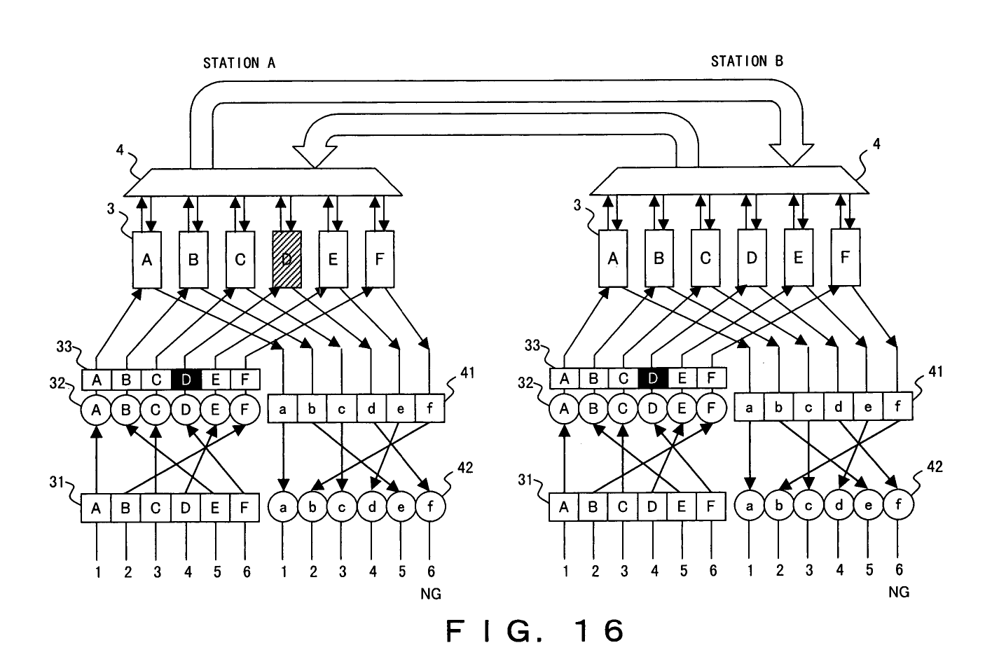

FIG. 15 explains the updating of data in the management table 50 at the A and B stations when the transponder 3B at the station A is recovered. The management tables at the A and B stations when the system is in the state of FIG. 14 is shown at the upper parts of FIG. 15. When the fault of the optical signal F is recovered, the control circuit 12 checks whether or not an optical signal which has a priority higher than that of the recovered optical signal F and in which a fault has occurred is present, using the management table 50. In the example of FIG. 15, such an optical signal E is detected. Then, “the output destination” of the optical signal F that is recovered and “the output destination” of the detected optical signal E are switched with each other. The lower parts of FIG. 15 show the management tables 50 after data is switched between the station A and the station B. FIG. 16 shows the state of the system that is set up in accordance with the management tables 50 shown in the lower parts of FIG. 15. At this time, the optical signal E is transmitted through the transponder 3B that has been recovered. The optical signal F, however, passes through the transponder 3D so that it becomes incommunicable.

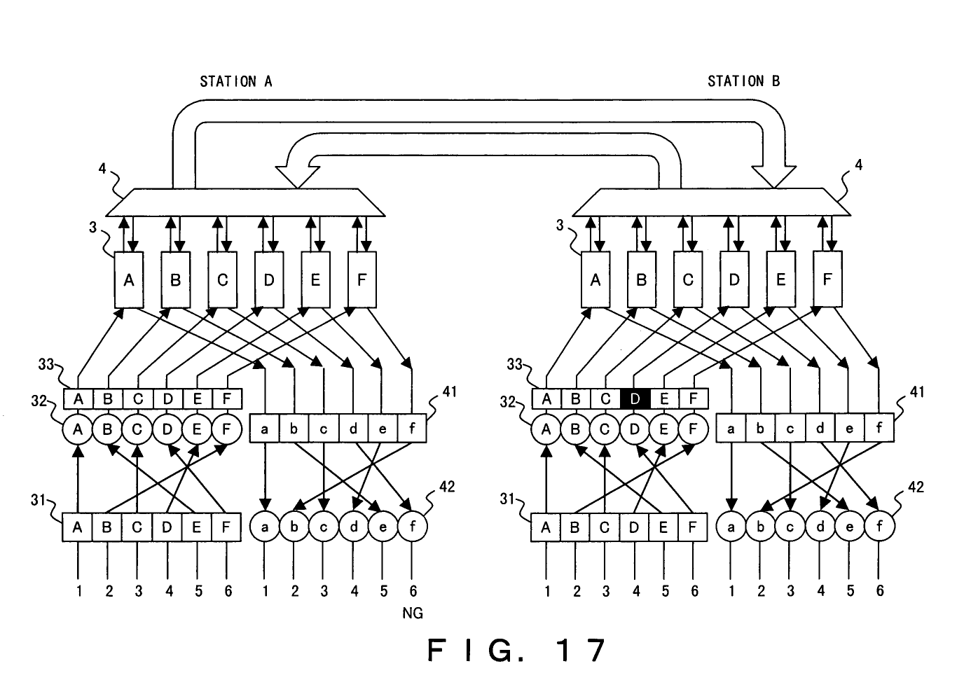

FIG. 17 is a pattern diagram showing the state of the system when the transponder 3D at the station A is recovered. When the transponder 3D is recovered from a fault, the optical shutter 33D corresponding to the transponder 3D is opened and the transmission of the optical signal F that was blocked up until now is started. This optical signal F is detected at the station B and the status 55 in the management table 50 is updated at the station B according to the instructions of the control circuit 12. The optical shutter 33D is opened by the automatic control at the station B in accordance with the updated management table 50 and accordingly the optical signal F is detected at the station A, thereby causing update of the management table 50 at the station A.

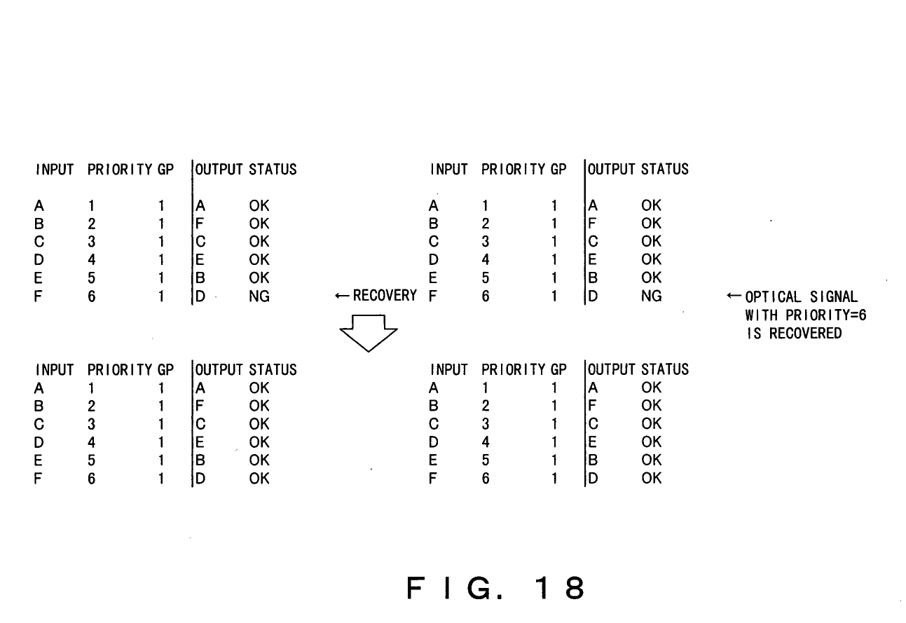

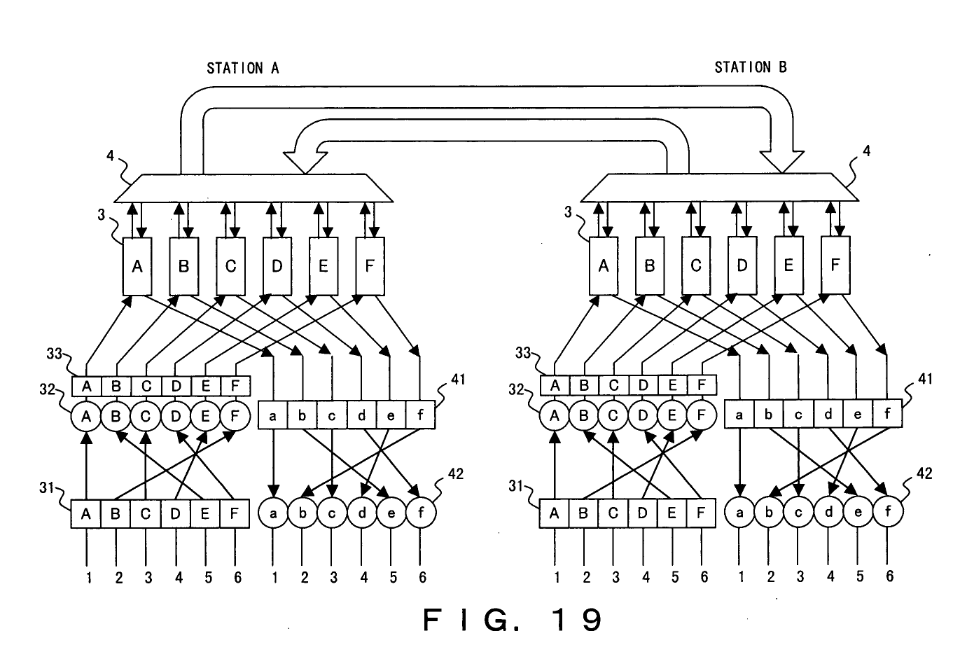

FIG. 18 explains the updating of data in the management table 50 at the A and B stations when the transponder 3D is recovered from a fault. The management tables at the A and B stations when the system is in the state of FIG. 17 are shown at the upper parts of FIG. 18. The management tables 50 when an optical signal F becomes communicable are shown in lower parts of FIG. 18. FIG. 19 is a pattern diagram showing the state of the system corresponding to the management tables 50 shown at the lower parts of FIG. 18.

When a fault is recovered in this way, the path of an optical signal that is transmitted through a transponder which is recovered is switched to that of an optical signal that has a priority higher than that of the optical signal itself and is incommunicable due to a fault. In the case where one of a plurality of transponders that fail is recovered, the transmission and receipt of the optical signal having the highest priority among a plurality of optical signals that are incommunicable can be restored.

It is appropriate that the output destination 54 data in the management table 50 is restored to that shown in FIG. 3 after the faults in respect of the communications of all the optical signals are recovered in this way. If such a function is provided, maintenance load, etc. can be reduced.

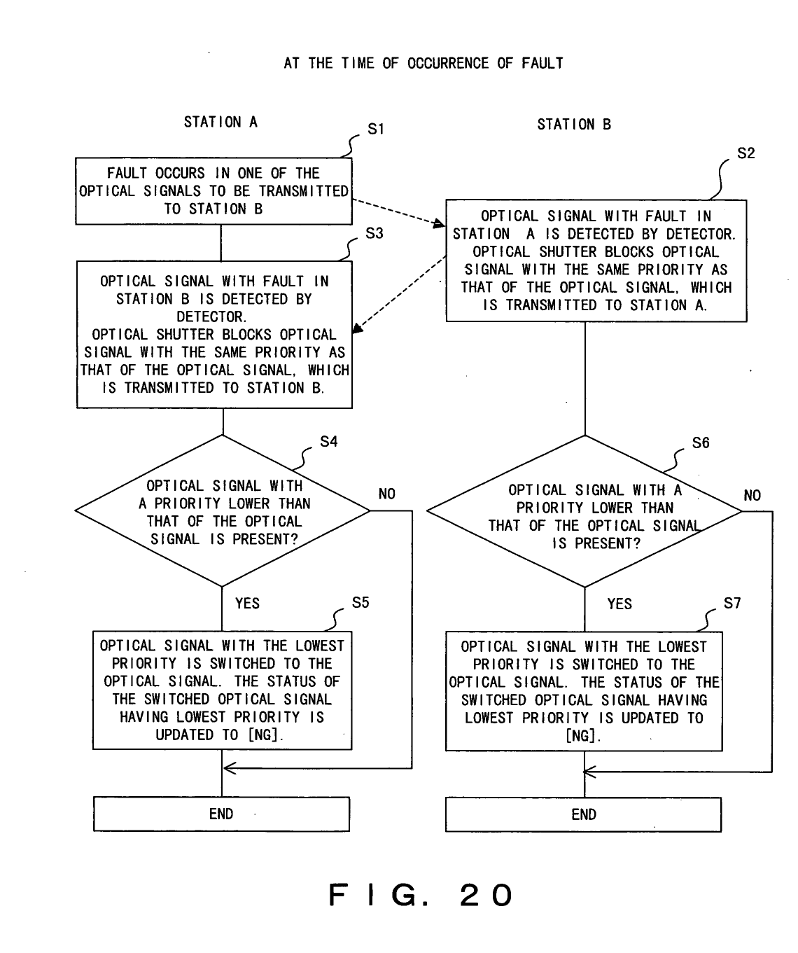

FIG. 20 shows flowcharts of the basic operations at the station A and also at the station B which communicates with the station A when a fault occurs in a signal at the station A. The following is an explanation of the operation processes at each station in reference to FIG. 20.

At the station A, a fault occurs in one of the optical signals that are transmitted to the station B (step S1). When transmission of the optical signal to the station B is interrupted by the fault, the corresponding optical signal that is transmitted to the station A from the station B is blocked. Consequently, when it is detected at the station A that the optical signal from the station B is not received, the optical shutter at the station A is closed (step S3).

It is determined at the station A whether or not there is an optical signal having a priority lower than that of an optical signal that cannot be transmitted due to a fault, in which a fault does not occur during communications, with reference to the management table 50 (step S4). In the case where such a corresponding optical signal exists, “the output destination” of the optical signal in which a fault has occurred is switched with “the output destination” of the detected optical signal (step S5) and the process terminates. In the case where there is no such corresponding optical signal, the process terminates without performing switching.

At the station B, the occurrence of a fault at the station A is detected by the fact that an optical signal is not received by the detector 11 at the station B. The optical shutter 33 is closed so as to block transmission to the station A of an optical signal that has the same priority as that of the optical signal that is not received (step S2). The processes in steps S6 and S7 that are implemented at the station B are the same as those that are implemented at the station A in steps S4 and S5.

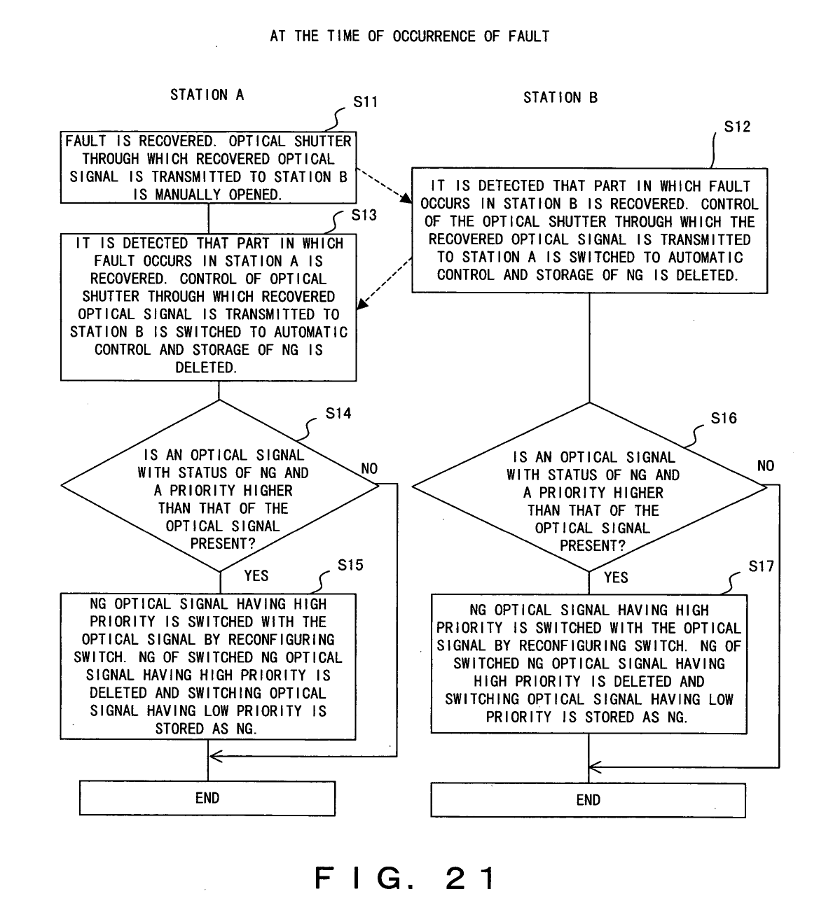

FIG. 21 shows flowcharts of basic operations at the station A and the station B. The station B is communicating with the station A when a fault is recovered at the station A. The following is a detailed explanation of the processes at each station in reference to FIG. 21.

When a fault is recovered at the station A, the corresponding optical shutter 33 is opened and the transmission of an optical signal is started (step S11). At the station B where the optical signal is received, the transmission of the optical signal to be transmitted to the station A from the station B is started. When the optical signal from the station B is detected at the station A, the data corresponding to the status 55 of the detected optical signal in the management table 50 is updated from “NG” to “OK” (step S13).

It is determined in reference to the management table 50 whether or not there is an optical signal having a priority higher than that of an optical signal which is transmitted through a transponder which has been recovered from a fault and in which a fault has occurred (step S14). In the case where the corresponding optical signal exists, “the output destinations” of two optical signals are switched with each other (step S15) and processing terminates. In the case where there is no corresponding optical signal, processing terminates without performing the switch.

At the station B, the optical signal that has not been received so far is detected by the detector 11 at the station B, the corresponding optical shutter 33 is opened, the corresponding optical signal is transmitted from the station B to the station A and at the same time, the status 55 data in the management table 50 is updated from NG to OK (step S12). The processes in steps S16 and S17 that are implemented at the station B are the same as those of steps S14 and S15 that are implemented at the station A.

The above explanation is given for the transmission apparatus related to the present preferred embodiments but the present invention is not limited to this configuration. For example, the path switch apparatus 10 can achieve the above described mentioned operations and effects even if it is configured in another way.

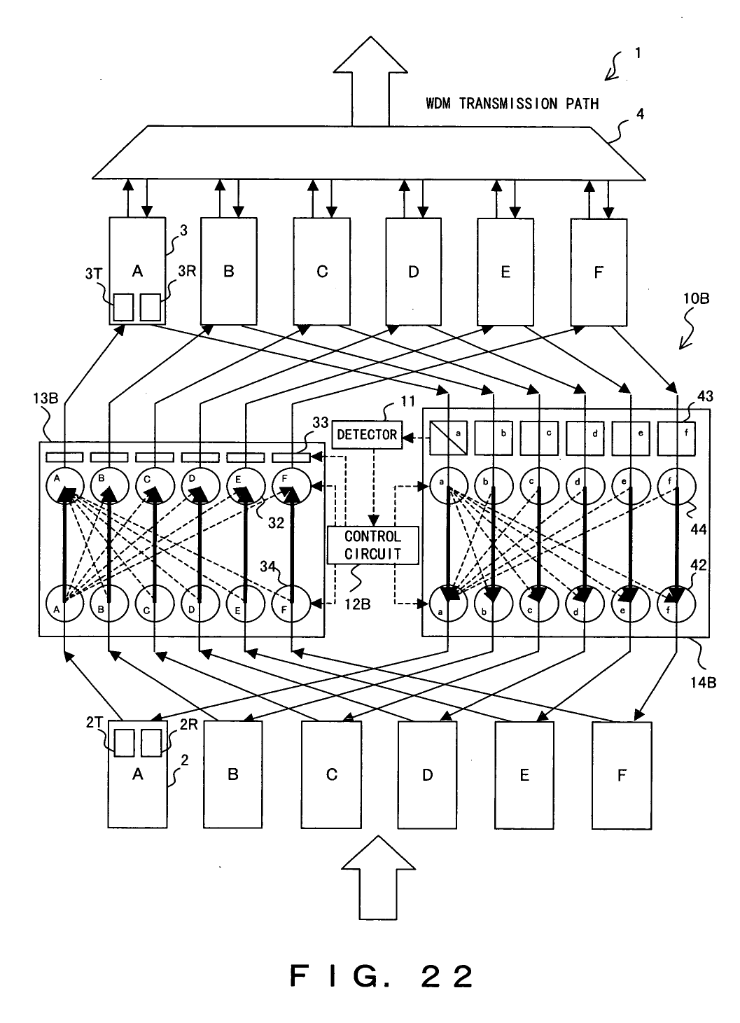

The path switch apparatus 10B that is shown in FIG. 22 includes a control circuit 12B, a transmission signal switch circuit 13B and a reception signal switch circuit 14B in addition to the detector 11 that is described above.

The transmission signal switch circuit 13B is provided with six optical switches 34 instead of the six optical couplers 31 that are shown in FIG. 2. Each optical switch 34 guides the optical signal that is generated by the corresponding optical transceiver apparatus 2 to the optical switch 32 that is controlled by the control circuit 12B. A reception signal switch circuit 14B is provided with six optical couplers 43 and six optical switches 44 instead of the six optical couplers 41. Each optical coupler 43 splits a component of the optical signal from the corresponding transponder 3 and guides the split components to the detector 11. Furthermore, each optical switch 44 guides the optical signal from the corresponding optical coupler 43 to an optical switch 42 that is controlled by the control circuit 12B.

When the path switch apparatus 10B configured as shown in FIG. 22 is applied to a transmission apparatus, the optical signal to be transmitted is not split by an optical coupler in the path switch apparatus 10B. Therefore, the apparatus has the effect of controlling the attenuation of the optical signal and improves the quality of communications. Furthermore, the apparatus is also suitable for the case where many wavelengths are multiplexed since the attenuation of the optical signal is limited.

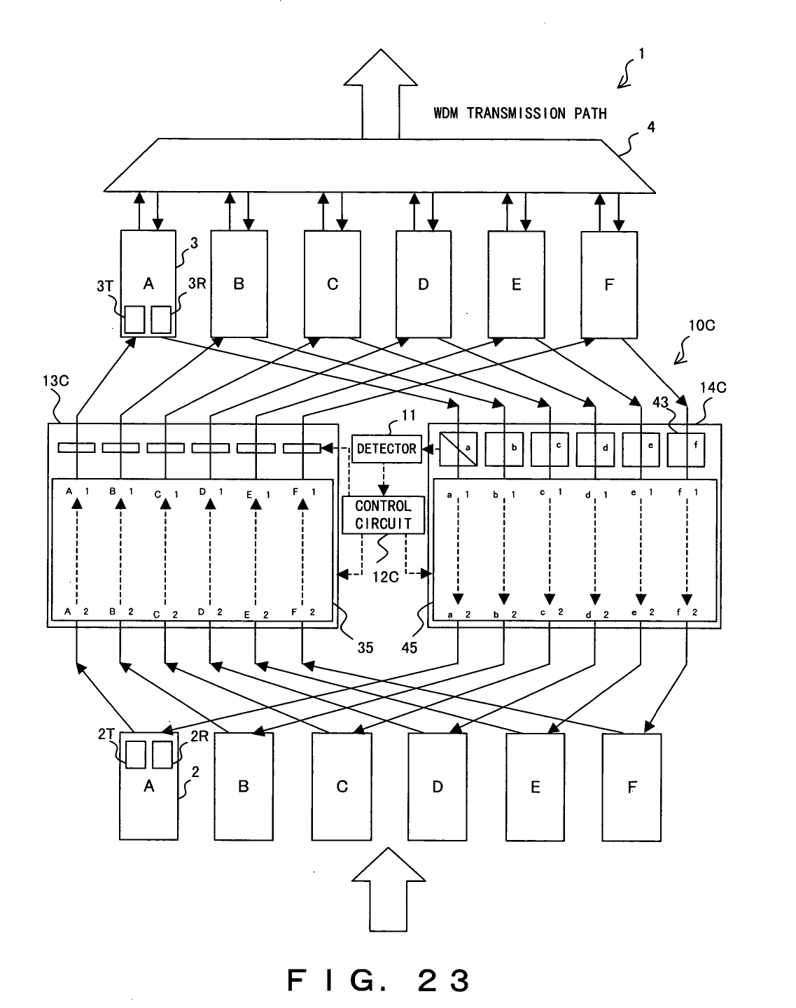

A path switch apparatus 10C that is shown in FIG. 23 includes a control circuit 12C, a transmission signal switch circuit 13C and a reception signal switch circuit 14C in addition to the above-mentioned detector 11.

The transmission signal switch circuit 13C is similar to the above described configuration in that it is provided with an optical shutter 33. However, it uses a MEMS (Micro Electro Mechanical Systems) switch 35 for switching the paths of the optical signals to be transmitted. The reception signal switch circuit 14C is similar to the configuration shown in FIG. 22 in that it is provided with six optical couplers 43. However, it uses a MEMS switch 44 for switching the paths of the received optical signals. The control circuit 12C controls the optical shutter 33 and two MEMS switches 35 and 45 on the basis of the detection results of the detector 11.

If the transmission apparatus is configured in such a way that the path of an optical signal is switched using a MEMS switch, it has the effect of controlling the attenuation of an optical signal, thereby contributing to the improvement of the communication quality in the same way as in the transmission apparatus of FIG. 22.

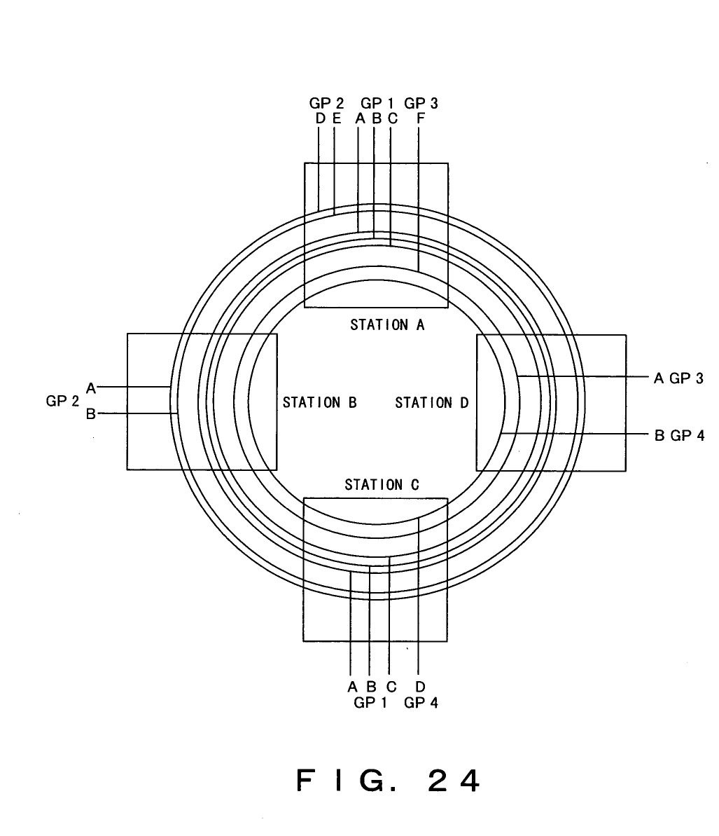

Further, the optical transmission apparatus related to the present invention is not limited to the communications of a one-to-one connection but it is applicable to, for example, the case of configuring a ring-shaped network. FIG. 24 is a block diagram showing the configuration of a ring-shaped network. Four stations, a station A to a station D, are connected to the ring-shaped network. In FIG. 24, each station comprises a transmission apparatus that enables WDM transmission. In the present preferred embodiments, the WDM transmission path of three channels is set up between a station A and a station C, a WDM transmission path of two channels is set up between the station A and a station B, a WDM transmission path of one channel is set up between the station A and a station D and a WDM transmission path of one channel is set up between the station C and the station D. Consequently, the A, B, C and D stations perform WDM transmission using, six-wavelengths, two-wavelengths, four-wavelengths and two-wavelengths, respectively.

In FIG. 24, four virtual networks that are defined as groups GP1 to GP4 are configured and it is predetermined to which communication group the optical signal belongs. The information about the group corresponding to the optical signal of a given wavelength is stored as the group information in a management table at each optical transmission apparatus.

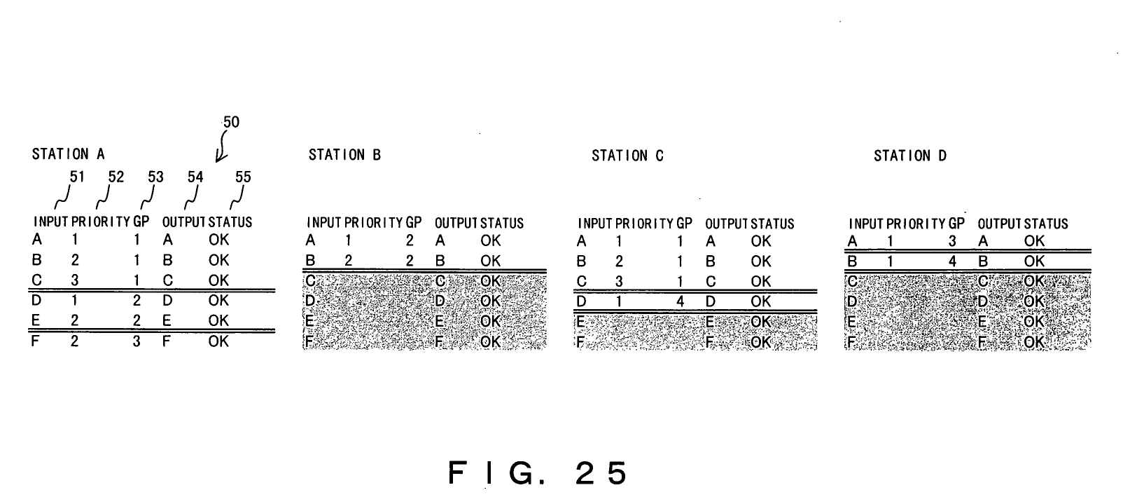

FIG. 25 shows a management table stored by a transmission apparatus connected to a ring-shaped network. Since the input source 51, the priority 52, the output destination 54 and the status 55 have been explained in reference to FIG. 3, their explanation is omitted here. A method of switching the paths of optical signals using a ring-shaped network on the basis of the group 53 is explained.

In the system configuration of FIG. 24, there are optical signals that are not used in WDM transmission of the B, C and D stations. Information with regard to the input source 51, the output destination 54 and the status 55 is managed in the management table 50; however information about the priority 52 and the group 53 corresponding to these optical signals is not stored in the management table 50. When the configuration of the system is changed and these optical signals are used, it is possible to perform WDM transmission for a optical signal that is not used in FIG. 25, using the method related to the present preferred embodiments by setting up un-established information in the management table 50.

The group 53 identifies the virtual network which each optical signal belongs to. When the management table 50 at the station A shown in FIG. 25 is taken for example, the optical signals that are transmitted and received by the optical transceiver apparatuses 2A, 2B and 2C belong to a group GP1 and priorities 1, 2 and 3 are assigned, respectively. Each of the optical signals used in other groups GP2 and GP3 is assigned a priority in each group in the same way as in the group GP1.

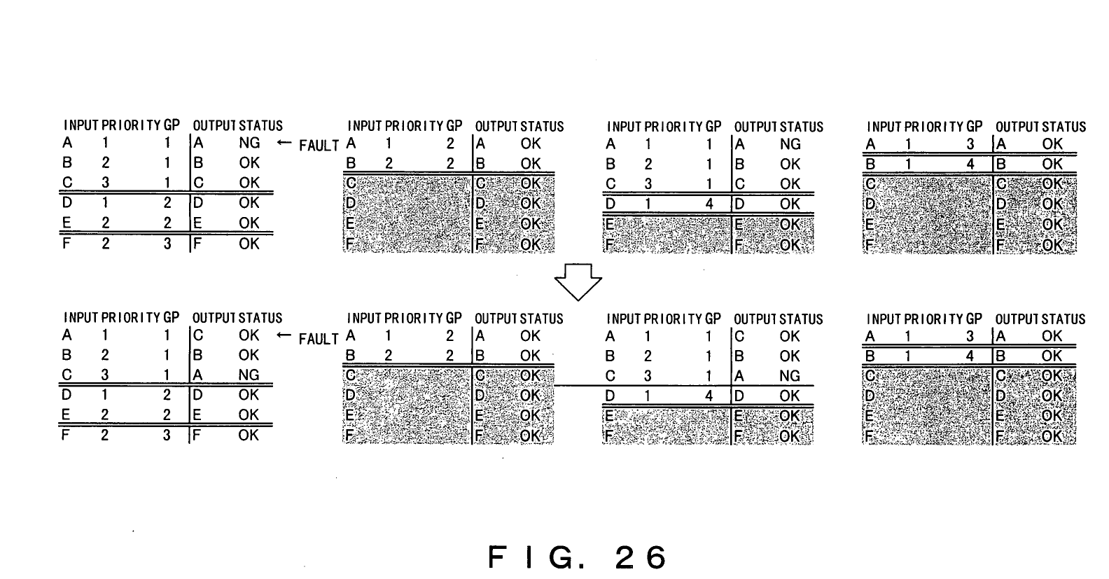

It is assumed that the transponder for transmitting an optical signal A fails at the station A. FIG. 26 shows the management table of each station before and after the fault occurs. In FIG. 26, the upper part indicates the management tables in the respective stations before the fault occurs while the lower part indicates the management tables after the fault occurs.

When a fault occurs in an optical signal A at the station A as shown in the upper part in the FIG. 26, the fault is detected at the station C receiving the optical signal A. Subsequently, the fault is also detected at the station A, since reception of the optical signal A from the station C at the station A is interrupted. The management tables 50 at the station A and the station C are updated. The operations of detecting a fault in the A and C stations are similar to those described in the previously explained method, thus the explanation is omitted here. In the A and C stations, the management table is retrieved and the output destinations 54 are switched between a faulted optical signal and an optical signal which is operational and which has the lowest priority of the optical signals that belong to the group GP1. The management table in which the output destinations 54 are switched is shown in the lower part of FIG. 26. In each of the A and C stations, the output destination of the optical signal A in which a fault is detected is switched to that of an optical signal C.

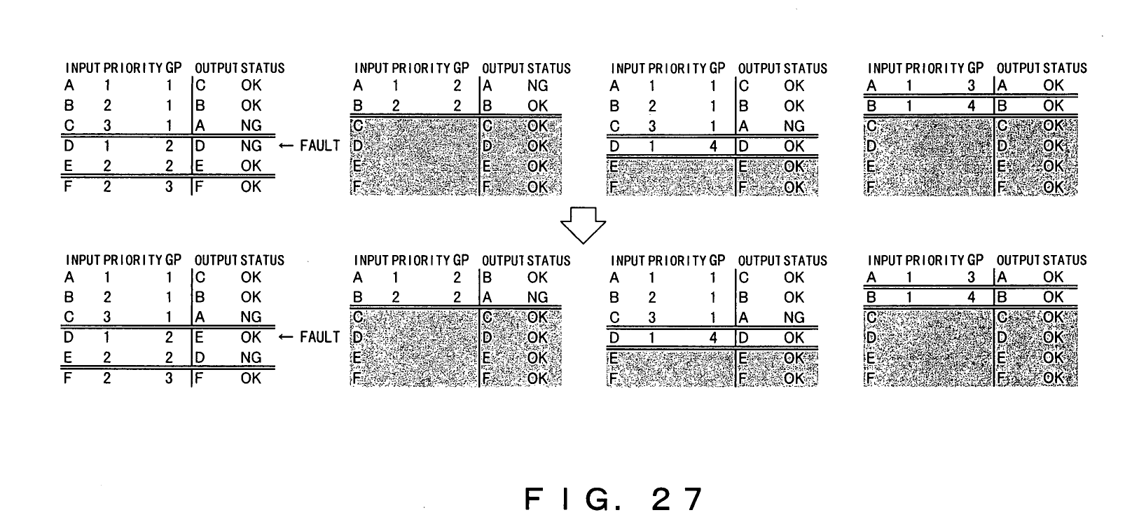

FIG. 27 shows the process of updating management tables when the transponder for transmitting an optical signal D fails at the station A. The explanation of the processing of switching paths in the switch circuit that is provided in an optical transmission apparatus to mitigate faults is omitted since this processing is fundamentally the same as the processing described above.

In respect of operations performed when a given optical signal is recovered from a fault, in order to preferentially transmit and receive an optical signal having a higher priority in a group, the output destination of the optical signal in which a fault occurs and which has a higher priority is switched with that of the optical signal which is recovered from a fault. The processing referring to the group 53 and switching the paths of optical signals in a group is different from the example of the above described one-to-one connection but the other processes are identical to those of the above described processes. Accordingly, their explanations are omitted here.

Even in the case where a ring-shaped network is configured, it can be determined which network an optical signal is connected to on the basis of the group information of a management table. Therefore, the transmission method related to the present preferred embodiment can be performed in the same way as in the one-to-one connection by switching a set of paths of optical signals in a group.

In the above-mentioned preferred embodiment, different priorities are respectively assigned to the plurality of optical signals included in WDM signals, but the present invention is not limited to this configuration. In other words, it is assumed that, for example, the highest priority is set to each of the optical signals A and B, the second highest priority is set to each of the optical signals C and D and the lowest priority is set to each of the optical signals E and F. In this case, for example, when a fault occurs in the optical signal A, the path of the optical signal A is switched to one of the paths of the optical signals E or F in the switch circuit of each optical transmission apparatus.

As mentioned above, even in the case where a certain optical signal cannot be transmitted and received due to the occurrence of a fault in the transmission apparatus and the transmission system related to the present preferred embodiment, the paths of optical signals are switched in order that the optical signal having a higher priority can be preferentially transmitted and received. Since the apparatus for switching the paths of optical signals includes an optical coupler, a switch, etc., a redundant configuration for each wavelength can be realized at low cost and with a simple configuration without requiring redundant wavelength converters.

What is claimed is:

1. An optical transmission apparatus that is used in an optical transmission system for transmitting and receiving WDM signals corresponding to each other among nodes, comprising:
a plurality of optical signal generators for respectively generating optical signals;
a plurality of wavelength converters for generating a plurality of optical signals to be multiplexed as WDM signals from among a plurality of optical signals generated by the plurality of optical signal generators;
an optical switch circuit provided among the plurality of optical signal generators and the plurality of wavelength converters, for switching paths among them;
a priority setting unit for setting the priorities of a plurality of optical signals generated by the plurality of optical signal generators;
a detection unit for detecting communication conditions of respective optical signals multiplexed as the received WDM optical signal; and
a control unit for switching paths in the optical switch circuit based on a priority set by the priority setting unit when a fault is detected by the detection unit.

2. The optical transmission apparatus according to claim 1, wherein
the control unit refers to the priority setting unit and switching the output destination of a first optical signal among the plurality of optical signals, corresponding to an optical signal in which a fault is detected by the detection unit, with the output destination of a second optical signal among a plurality of optical signals, which is being communicated and has a priority lower than that of the first optical signal in the optical switch circuit.

3. The optical transmission apparatus according to claim 2, wherein
the second optical signal is an optical signal having the lowest priority among the plurality of optical signals.

4. The optical transmission apparatus according to claim 2, further comprising
a block unit provided between the optical switch circuit and the plurality of wavelength converters, for blocking the second optical signal in accordance with the control unit.

5. The optical transmission apparatus, according to claim 1, wherein:
the control unit refers to the priority setting unit and switches the output destination of a third optical signal, among a plurality of optical signals, corresponding to an optical signal in which recovery of a fault is detected by the detection unit, with the output destination of a fourth optical signal, among the plurality of optical signals, which is not being communicated and has a priority higher than that of the third optical signal in the optical switch circuit.

6. The optical transmission apparatus according to claim 1, wherein
the optical switch circuit comprises:
a plurality of optical demultiplexing devices for demultiplexing optical signals generated by a corresponding optical signal generator; and
a plurality of optical switches for selecting one component optical signal controlled by the control unit from among a plurality of component optical signals caused by the plurality of splitting devices, thereby outputting the selected optical signal to a corresponding wavelength converter.

7. The optical transmission apparatus according to claim 1, wherein
the optical switch circuit comprises:
a plurality of first optical switches for respectively guiding an optical signal generated by a corresponding optical signal generator to an output destination controlled by the control unit; and
a plurality of second optical switches connected to the plurality of first optical switches, for respectively guiding an optical signal transmitted from the first optical switch controlled by the control unit to a corresponding wavelength converter.

8. The optical transmission apparatus according to claim 1, wherein
the optical switch circuit is an MEMS switch.

9. An optical transmission apparatus that is used in an optical transmission system for transmitting and receiving WDM signals corresponding to each other among nodes, comprising:
a plurality of optical signal generators for respectively generating optical signals;
a plurality of optical receivers for respectively receiving optical signals;
a plurality of first wavelength converters for generating a plurality of optical signals to be multiplexed as a WDM signal from among a plurality of optical signals generated by the plurality of optical signal generators;
a plurality of second wavelength converters for converting wavelengths of a plurality of optical signals multiplexed as a WDM signal received from another node;
a first optical switch circuit provided among the plurality of optical signal generators and the plurality of first wavelength converters, for switching paths among them;
a second optical switch circuit provided among the plurality of second wavelength converters and the plurality of optical receivers, for switching paths among them;
a priority setting unit for setting priorities of the plurality of optical signals;
a detection unit for detecting communication conditions of respective optical signals multiplexed as a WDM optical signal received from another node; and
a control unit for switching paths in the first and second optical switch circuits based on a priority set by the priority setting unit if a fault is detected by the detection unit.

10. The optical transmission apparatus, according to claim 9, wherein:
the control unit refers to the priority setting unit, switches an output destination of a first optical signal among a plurality of optical signals that are multiplexed as a received WDM optical signal in which a fault is detected by the detection unit, with an output destination of a second optical signal which is being communicated and has a priority lower than that of the first optical signal in the second optical switch circuit and switches an output destination of a third optical signal with that of a fourth optical signal which correspond to the first and second optical signals among a plurality of optical signals generated by the plurality of optical signal generators in the first optical switch circuit.

11. The optical transmission apparatus according to claim 10, wherein
the second and fourth optical signals are optical signals each having the lowest priority among the plurality of optical signals.

12. The optical transmission apparatus according to claim 10, further comprising
a block unit provided among the first optical switch circuit and the plurality of wavelength converters, for blocking the fourth optical signal according to instructions from the control unit.

13. The optical transmission apparatus according to claim 9, wherein:
the control unit refers to the priority setting unit, switches an output destination of a fifth optical signal among a plurality of optical signals multiplexed as the received WDM signal in which recovery of a fault is detected by the detection unit, with an output destination of a sixth optical signal which is not being communicated and has a priority higher than that of the fifth optical signal in the second optical switch circuit and switches an output destination of a seventh optical signal with that of a eighth optical signal which corresponds to the fifth and sixth optical signals among a plurality of optical signals generated by the plurality of optical signal generators in the first optical switch circuit.

14. An optical transmission system for transmitting and receiving WDM signals corresponding to each other among nodes, wherein
an optical transmission apparatus provided in each node, comprising:
a plurality of optical signal generators for respectively generating optical signals;
a plurality of wavelength converters for respectively generating a plurality of optical signals to be multiplexed as a WDM signal from among a plurality of optical signals generated by the plurality of optical signal generators;
an optical switch circuit provided among the plurality of optical signal generators and the plurality of wavelength converters, for switching a plurality of paths between them;
a priority setting unit for setting priorities of a plurality of optical signals generated by the plurality of optical signal generators;
a detection unit for detecting communication conditions of respective optical signals multiplexed in the received WDM optical; and
a control unit for switching paths in the optical switch circuit based on a priority set by the priority setting unit when a fault is detected by the detection unit.

15. A transmission management apparatus provided in an optical transmission apparatus that is used in an optical transmission system for transmitting and receiving WDM signals corresponding to each other among nodes, comprising:
an optical switch circuit provided among a plurality of optical signal generators for respectively generating optical signals and a plurality of wavelength converters for generating a plurality of optical signals to be multiplexed as a WDM signal, from among a plurality of optical signals generated by the plurality of optical signal generators, for switching a plurality of paths between them;
a priority setting unit for setting priorities of a plurality of optical signals generated by the plurality of optical signal generators;
a detection unit for detecting communication conditions of respective optical signals multiplexed in the received WDM optical signal; and
a control unit for switching paths in the optical switch circuit based on a priority set by the priority setting unit when a fault is detected by the detection unit.

16. An optical transmission apparatus that is used in an optical transmission system for transmitting and receiving WDM signals corresponding to each other among nodes, comprising:
a plurality of optical signal generators for respectively generating optical signals;
a plurality of wavelength converters for generating a plurality of optical signals to be multiplexed as WDM signals from among a plurality of optical signals generated by the plurality of optical signal generators;
an optical switch circuit provided among the plurality of optical signal generators and the plurality of wavelength converters, for switching paths among them;
a priority setting means for setting the priorities of a plurality of optical signals generated by the plurality of optical signal generators;
a detection means for detecting communication conditions of respective optical signals multiplexed as the received WDM optical signal; and
a control means for switching paths in the optical switch circuit based on a priority set by the priority setting means when a fault is detected by the detection unit.
